(19) United States
(12) Patent Application Publication
(10) Pub. No.: US 2026/0359529 A1
(43) Pub. Date: Nov. 12, 2026

(54) METHOD FOR NUMERICAL SIMULATING AND MODELING UNIFORM FLOW IN OPEN CHANNELS

(71) Applicants: Hydraulic Research Institute of Ningxia Hui Autonomous Region., Yinchuan (CN); Ningxia University., Yinchuan (CN); Yinchuan University of Energy, Yinchuan (CN); Ningxia Vocational and Technical College of Industry and Commerce, Yinchuan (CN)

(72) Inventors: Xiaolong Han, Yinchuan (CN); Wenjie Ding, Yinchuan (CN); Yonggang Duan, Yinchuan (CN); Xiaozhen Han, Yinchuan (CN); Shihua Xin, Yinchuan (CN); Yuguang Wang, Yinchuan (CN)

(21) Appl. No.: 19/204,617

(22) Filed: May 12, 2025

(51) Int. Cl. G06F 30/28; G06F 111/10

(52) U.S. Cl. CPC G06F 30/28; G06F 2111/10

(57) ABSTRACT

A method for numerical simulating and modeling uniform flow in open channels includes steps as follows. Physical waterways are generalized into digital waterways composed of a binary tree, the flow of water in physical waterways is generalized as movement of rectangular strips on the binary tree, movement equation of rectangular strips is used to calculate changes in downstream water conditions, and irrigation production collaboration is organized. The method can calculate a trend of water condition changes in all downstream channel sections, thereby providing data support for subsystems such as gate operation simulation, flow statistical analysis, and intelligent gates, and thus achieving the application effects of efficiently formulating irrigation scheduling plans, optimizing irrigation operation schedules, reducing river patrol workload, improving water measurement accuracy, and coordinating mutual supervision among farmers to save water.

### TECHNICAL FIELD

The disclosure relates to the technical field of irrigation management, and particularly to a method for numerical simulating and modeling uniform flow in open channels.

### BACKGROUND

Generally, due to the relatively rudimentary irrigation management plans in irrigation districts, irrigation administrators need to travel back and forth between various sluice gates around the clock during the channel water conveyance period. They must repeatedly monitor and operate the sluice gates to ensure safety of embankments and timely and sufficient irrigation of crops. In modern times, the use of channel water condition remote measurement equipment and integrated measurement and control sluice gates has enabled real-time monitoring and remote control of water conditions, effectively ensuring the completion of irrigation management tasks. However, the high costs of channel construction and maintenance are difficult for governments, society, and water users to bear.

### SUMMARY

The disclosure provides a method for numerical simulating and modeling uniform flow in open channels. Assuming water condition V₀ⱼ at a head of the main channel for a certain period, and given the changes in the opening Gᵢⱼ of each gate, the method aims to determine spatiotemporal distribution Vᵢⱼ of water flow, where i represents the gate number and j represents the time sequence. Solving this problem can facilitate the efficient formulation of irrigation scheduling plans, optimize irrigation operation schedules, reduce the workload of river patrolling, improve the accuracy of water measurement, and coordinate the mutual supervision among farmers to save water.

To achieve the above objectives, the disclosure provides the following solutions.

A method for numerical simulating and modeling uniform flow in open channels includes steps as follow.

Digital waterways composed of a binary tree are constructed based on physical waterways. Water flow movement environment in the physical waterways is generalized into node parameters corresponding to the digital waterways. A water flow movement equation in the physical waterways is performed with dimensionality reduction into a movement equation of rectangular strips on the binary tree in the digital waterways. The movement equation of rectangular strips includes types of water movement within tree nodes and impact of movement changes between the tree nodes. The impact of movement changes represents influence of changes in a water channel and water flow movement on upstream water conditions and downstream water conditions. The rectangular strips are configured to describe manifestation of water conditions at tree nodes on a time axis. Changes in the downstream water conditions are calculated based on the node parameters and the movement equation, and an irrigation scheduling plan for production cooperation is determined based on the changes in the downstream water conditions. The irrigation scheduling plan includes information of gates on opening and closing times, openings, planned flow rates, duration, and total water usage.

In an embodiment, the constructing digital waterways composed of a binary tree based on physical waterways includes: dividing the open channel into sections using a finite element method, connecting the sections into a binary tree, determining a topological structure of the digital waterways (i.e., channel system), and determining dual constraint parameters of the open channel and the gates (i.e., a digital water movement constraint condition). The determining a topological structure of channel system includes: generalizing the physical waterways into a tree-like structure based on a natural structure of an irrigation area, and simplifying the tree-like structure into the binary tree owing to the fact that there is no need to distinguish between left and right banks in a process of simulating and modeling. The discretizing the digital waterways includes: dividing the physical waterways into multiple channel sections based on positions of water intakes, and the channel sections have a same constraint condition and a same water movement equation. The digital water movement constraint condition includes physical parameters of the physical waterways, physical parameters of the gates, flow coefficients of the gates, and a fluid mechanics constraint. A water flow movement form of the water movement equation in the digital waterways includes an open channel uniform flow, water storage before closure of a regulating gate, open the gate for drainage, and submerged flow caused by the rise of a water level due to a submerged dam.

In an embodiment, the discretizing the digital waterways further includes coding the multiple channel sections, and steps of the coding the multiple channel sections are as follows: a parent node of the binary tree is set as Vₙ, a child node is set as V₂ₙ, and a second child node is set as V₂ₙ₊₁. The parent node Vₙ is an upstream channel section of the child node V₂ₙ, the second child node V₂ₙ₊₁ is a water intake gate, and a direction corresponding to an increasing order represents a water flow direction. a water intake gate on a main channel {V₁, V₂, . . . V₂ₙ, . . . } is represented as Gᵢ∈{V₂ₙ}, and a regulating gate on the main channel {V₁, V₂, . . . V₂ₙ, . . . } is represented as Pᵢ∈{V₂ₙ₊₁}. The determining a topological structure of the digital waterways further includes addition calculations of convergence or summarize irrigation applications, and steps of the addition calculation process are as follows: water condition of an upstream node of the parent node Vₙ is set as a sum of water condition of a downstream node of the child node V₂ₙ and water condition of the water intake gate of the second child node V₂ₙ₊₁. The addition calculation process is graphically represented as a union operation of two rectangular strips over a time period T, and is mathematically expressed as Vₙ=V₂ₙ+V₂ₙ₊₁. The determining a topological structure of the digital waterways further includes subtraction calculations of distributary or water intake diversion, which is an inverse operation of the addition calculation process, and steps of the subtraction calculation process are as follows: the water condition of the downstream node over the time period T is determined as a difference between the water condition of the upstream node and the water condition of the water intake gate. The subtraction calculation process is graphically represented as a difference operation of two rectangular strips over the time period T, and is mathematically expressed as V₂ₙ=Vₙ−V₂ₙ₊₁. The determining a topological structure of the digital waterways further includes a calculation process of displacement, and steps of the calculation process of displacement are as follows: after passing through a channel section with a length of Lₙ, water condition on a first channel section is expressed as follows: the water condition of the child node V₂ₙ is represented as a right shift of the rectangular strip on the parent node Vₙ by Lₙ/Vₙ. Water conditions of adjacent two nodes are obtained by a union operation, an intersection operation, a difference operation, and a shift operation in two dimensions of time and flow rate.

In an embodiment, the determining a water movement equation in the digital waterways includes steps as follows. In response to the water flow movement form corresponds to the open channel uniform flow, a natural flow of open channel water is generalized as the open channel uniform flow, and the water flow movement equation is expressed as Q=SV, where Q represents a flow rate, S represents a cross-sectional area of a channel section, and V represents a flow velocity. In response to a water flow movement form corresponding to the water storage before closure of the regulating gate, when an opening of the regulating gate decreases, the water storage is conducted in the channel section in front of the regulating gate, the water level is caused to rise gradually, and the water flow movement equation is expressed as R=ΔQT, where R represents storage capacity, ΔQ represents a difference between a flow rate entering a channel section and a flow rate exiting the channel section, and T represents a time period. In response to a water flow movement form corresponds to the pressurized water discharge when the regulating gate is opened, when the regulating gate is opened to release water, thereby causing the opening of the regulating gate to gradually increase. The water flow movement equation is expressed as Q=F(H, h, a, e, dh/dt, dH/dt, S/s), where Q represents a flow rate, F represents a function of Q, H represents a water level in front of the regulating gate, h represents a water level behind the regulating gate, a represents the opening of the regulating gate, e represents a flow coefficient, t represents time, S represents a cross-sectional area of a channel section, and s represents a cross-sectional area of another channel section. In response to the water flow movement form corresponds to submerged flow caused by rise of the water level due to the submerged dam, when diverting water to fields with higher terrain, a submerged dam is used to raise the water lever, the water flow movement equation is expressed as ΔZ=F(q, H, b, V, e), where q represents a flow rate across the submerged dam, F represents a function of q, H represents a total water head at a top of the submerged dam, b represents a top width of an overflow channel section of the submerged dam, V represents a flow velocity, e represents a flow coefficient, and ΔZ represents a backwater height.

In an embodiment, the calculating changes in the downstream water conditions based on the node parameters and the movement equation includes following steps. Water condition at each node, water condition of an upstream node of each node, physical parameters of a channel section, the openings of the gates, and flow coefficients of the gates are calculated when the rectangular strips move on the binary tree, where V_{water condition of downstream node}=F (V_{water condition of upstream node}, G_{opening of gate}). The water condition of the downstream node is used as a dependent variable, and the water condition of the upstream node and the opening of the gates are used as independent variables to iteratively calculate representation of the rectangular strips at all downstream nodes and convert the representation into node water condition information. The physical parameters of the channel section are constants obtained through measurement, the flow coefficients of the gates are constants obtained through testing and calibration, and the node water condition information includes: a flow rate, a velocity, a water level, and duration corresponding to the node.

In an embodiment, a process for iteratively calculating the representation of the rectangular strips at all downstream nodes and converting the representation into the node water condition information includes steps as follows. The representation of the rectangular strips at the all downstream nodes is manifested as a stack of rectangular strips, and spline curves is used to smooth the stack of rectangular strips, thereby forming a predicted water condition information. The predicted water condition information is compared with actual monitoring water condition information, and parameters of the digital waterways are accordingly revised. A flow loss and an energy loss during a water conveyance process are determined based on the predicted water condition information and the actual monitoring water condition information, and a final node water condition information (i.e., the node water condition information or movement information of de Saint-Venant system of equations) is obtained based on the flow loss and the energy loss.

In an embodiment, the method of the disclosure serves as a core module of an irrigation scheduling platform and functions to optimize irrigation scheduling plans, the disclosure performs “first root traversal binary tree” to simulate the movement of digital twin water flow, and performs “second root traversal binary tree” to drive a two-dimensional rectangular strip packing algorithm under multiple constraints, thereby performing continuous binary tree traversal. In addition, based on the traversal results, adjustments are made to the gate operation time and gate opening, and thereby exploring the optimal gate operation plan and irrigation schedule.

In an embodiment, the irrigation scheduling platform sends the irrigation scheduling plan to a mobile device of the operator. The operator then performs gate opening and closing operations based on parameters such as the timing, gate opening degree, planned flow rate, duration, and total water usage specified in the plan. Water users feedback the execution results back to this module, which achieves a bidirectional feedback mechanism between irrigation scheduling and water flow motion, this simulating and modeling system recalculates the subsequent irrigation scheduling plan in real-time based on the feedback. The method of the disclosure adapts to the application scenario of “massive gates-complex canal networks-dispersed users,” and accommodates farmers' random water withdrawal behavior. As a result, the robustness of the open platform is enhanced.

According to the specific embodiments provided by the disclosure, the technical effects of the disclosure are as follows.

The disclosure provides a method for numerical simulating and modeling uniform flow in open channels. The method includes generalizing the physical waterways into the digital waterways composed of the binary tree, performing dimensionality reduction the water flow movement in the channel (i.e., the physical waterways) as the movement of rectangular strips on the binary tree, and using the movement equation of rectangular strips to calculate the changes in the downstream water conditions, thereby organizing irrigation production cooperation. The disclosure is capable of calculating the changing trends of water conditions in all downstream channel sections. Thus, it can provide data support for subsystems such as gate operation simulation, flow statistical analysis, and intelligent gates. Consequently, it can achieve the application effects of efficiently formulating irrigation scheduling plans, optimizing irrigation operation schedules, reducing the workload of river patrolling, improving the accuracy of water measurement, and coordinating the mutual supervision among farmers to save water.

### BRIEF DESCRIPTION OF DRAWINGS

To more clearly illustrate the embodiments of the disclosure or the technical solutions in the related art, a brief introduction to the attached drawings required in the specification of the embodiments or the related art will be provided below. It is evident that the attached drawings described below are merely exemplary. For those skilled in the art, without the need for creative effort, other implementation drawings can be derived based on the provided drawings.

FIG. 1 illustrates a logical flowchart of numerical simulating and modeling uniform flow in open channels in an embodiment of the disclosure.

FIG. 2 illustrates a mapping relationship among a physical waterway, a digital waterway, and irrigation scheduling in the embodiment of the disclosure.

FIG. 3 illustrates a schematic diagram of a single channel section in the embodiment of the disclosure.

FIG. 4. illustrates a schematic diagram of numerical fitting of water conditions in the embodiment of the disclosure.

FIG. 5 illustrates a schematic diagram of an interpolation channel section of water conditions in the embodiment of the disclosure.

FIG. 6 illustrates a structural diagram of a system in the embodiment of the disclosure.

### DETAILED DESCRIPTION OF EMBODIMENTS

Below is a clear and complete description of the technical solutions in the embodiments of the disclosure, in conjunction with the attached drawings. It is evident that the described embodiments are only a part of the embodiments of the disclosure, not all of them. All other embodiments obtained by those skilled in the art without creative labor, based on the embodiments of the disclosure, are within the scope of protection of the disclosure.

The disclosure provides a method for numerical simulating and modeling uniform flow in open channels, which can facilitate the efficient formulation of irrigation scheduling plans, optimize irrigation operation schedules, reduce the workload of river patrols, improve the accuracy of water measurement, and coordinate mutual supervision among farmers to save water.

In order to make the above objectives, features, and advantages of the disclosure more apparent and understandable, the following will provide further detailed explanations of the disclosure in conjunction with the attached drawings and specific embodiments.

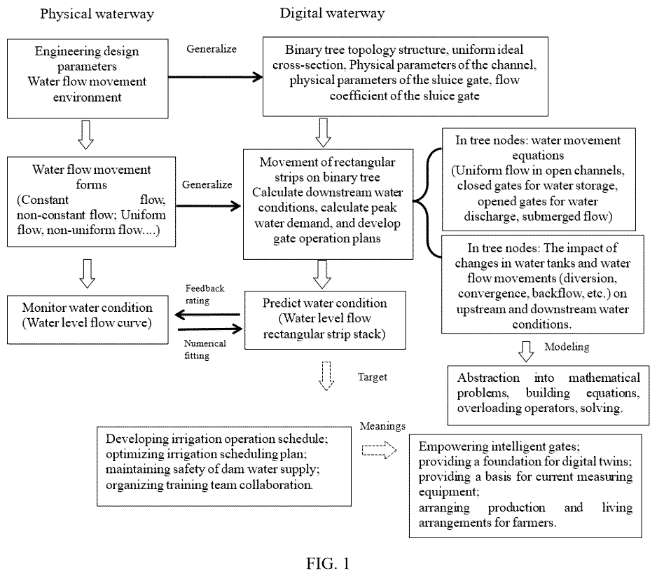

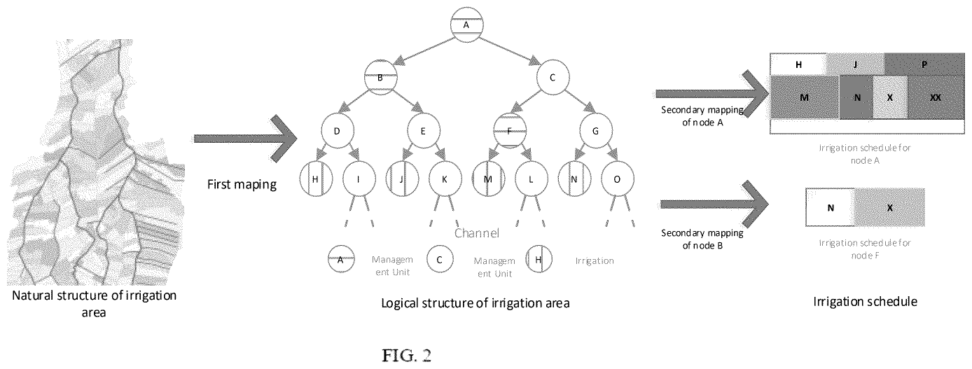

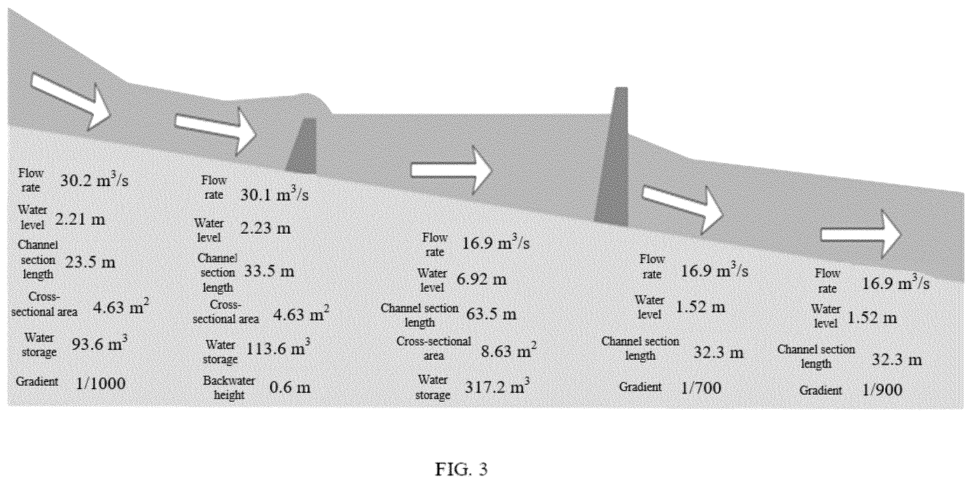

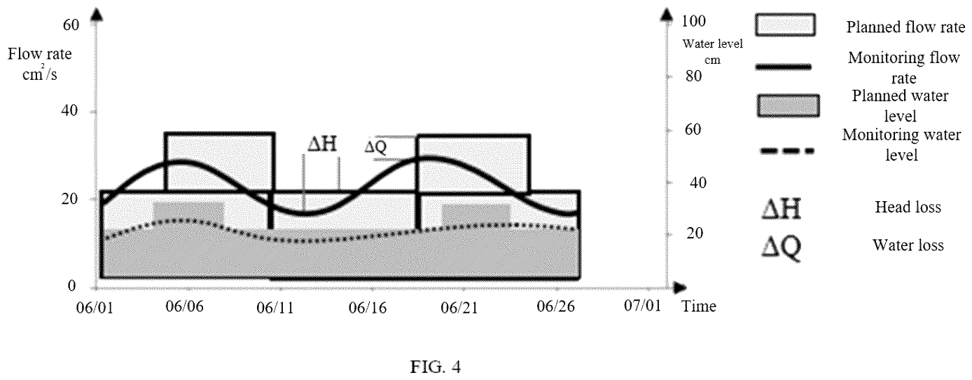

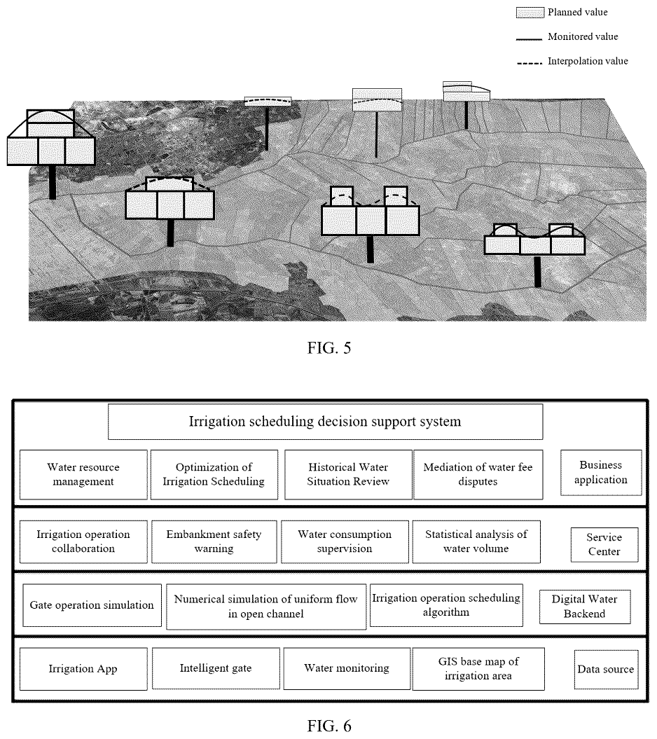

As shown in FIGS. 1-6, a method for numerical simulating and modeling uniform flow in open channels is provided, and the method includes steps as follows.

S100: Physical waterways are discretized and generalized into digital waterways composed of a binary tree.

S200: Water flow movement environment in physical waterways (i.e., channel) is generalized into physical parameters of physical waterways, physical parameters of gates, flow coefficients of the gates, and a fluid mechanics constraint.

S300: The water flow movement within the channel sections assumed to be steady flow is generalized into rectangular strips on tree nodes in the digital waterways. The water flow movement between the channel sections is generalized into operations such as a deformation operation, a shift operation, a union operation, an intersection operation, and a difference operation of the rectangular strips.

S400: According to the needs of irrigation district management, functional relationships and iterative calculations between inflow rate, water diversion rate, and gate opening are established. The water conditions at the inflow are simulated, the gate opening and closing operations are simulated, and the water conditions in downstream channel sections are calculated.

S500: “Predicting water conditions” and “monitoring water conditions” verify each other, the method of “when data is insufficient, the model compensates, and when the model is insufficient, data compensates” is used to interpolate time series of water conditions in each channel section, clarify water loss and energy loss.

S600: Technical supports for formulating scientific and rational irrigation scheduling plans, irrigation operation schedules, precise water measurement, water fee collection, coordinating mutual supervision among farmers are provided to save water, and guiding river patrol management work.

In the embodiment, first, the physical waterways (i.e., channel) are discretized and generalized into the digital waterways composed of the binary tree. Then, the water flow movement environment in the channel is generalized into physical parameters of the physical waterways, physical parameters of the gates, flow coefficients of the gates, and a fluid mechanics constraint. Further, the water flow in the physical waterways is generalized as the movement of the rectangular strips on the binary tree. A movement equation of rectangular strips is used to calculate changes in downstream water conditions and organize irrigation production collaboration. Through the above methods, the water conditions (such as time, flow, and water level) in each channel section are simulated, and the operations of all gates under various switching operations (such as operation time and gate opening) are simulated. Change trends of water conditions in all channel sections within watershed are predicted (such as numerical simulation). This provides technical support for accurately establishing the irrigation scheduling plan for an entire irrigation area, guiding the operation of each gate, coordinating the progress of irrigation operations, and improving the accuracy of water measurement. It also offers references and insights for digital twin irrigation areas. Through the above methods, the change trends of water conditions in all downstream channel sections under various constraint conditions are calculated, thereby providing technical support for formulating scientific and reasonable irrigation scheduling plans, irrigation operation schedules, precise water measurement, and water fee collection.

Furthermore, the constructing digital waterways composed of the binary tree based on physical waterways includes steps as follows. The open channel is divided into sections using a finite element method, the sections are connected into a binary tree, a topological structure of a channel system is determined, and dual constraint parameters of the open channel and the gates are determined to obtain a water flow movement form.

Steps of determining the topological structure of the channel system are as follows: the physical waterways are generalized into a tree-like structure based on a natural structure of an irrigation area, and the tree-like structure is simplified into the binary tree owing to there is no need to distinguish between left and right banks in a process of simulating and modeling.

Steps of discretizing the digital waterways (the dividing open channel into multiple channel sections using a finite element method) are as follows: the physical waterways are divided into multiple channel sections based on positions of water intakes, and the multiple channel sections have a same constraint condition and a same water movement equation.

The digital water movement constraint condition (i.e. dual constraint parameters) includes physical parameters of the physical waterways, physical parameters of the gates, and flow coefficients of the gates, and a fluid mechanics constraint.

The water flow movement form in the digital waterways includes: an open channel uniform flow from a natural flow, an open channel temporarily stores water cause by closing a regulating gate, drainage cause by open the gate, and a submerged flow cause by a submerged dam.

The rectangular strips represent a uniform flow, which is manifestation of the water conditions at the tree nodes on a time axis.

In a specific embodiment, in the field of irrigation management, when simulating and modeling the entire channel system, the flow in the physical waterways is usually generalized as “uniform flow”. It is represented as a rectangular strip on a flow-time coordinate axis, which is convenient for planning and management, easy for farmers to understand, and beneficial for calculation and statistical analysis. During the specific measurement of the channel sections, it can be expanded into “non-uniform flow”, represented as a polygon on a coordinate axis, to improve the accuracy of flow measurement. In the corresponding program design, the uniform flow is the parent class, and non-uniform flow is its subclass.

Furthermore, after the physical waterways are discretized into the channel sections, the water flow movement form on the tree nodes is divided into four types: an open channel uniform flow, water storage before closure of a regulating gate, pressurized water discharge when the gate is opened, and submerged flow caused by rise of a water level due to a submerged dam. The disclosure assumes that within a small channel section along a way (Δd) and a short period of time (Δt), the water flow can be approximated as a constant motion equation, that is, an expression of flow Q=F(t) and a water level L=G(t), which can be generalized as the motion equation of the rectangular strips on a flow-time coordinate graph.

In addition, the water flow diversion, convergence, backwater, and storage between the tree nodes can be summarized as the addition and subtraction, stacking, binning, and boxing of the rectangular strips. Through the iteration, the flow at a water intake gate on the main channel is distributed to each field outlet.

Furthermore, when mapping the “rectangular strips in the digital waterways” back to the “water flow in the physical waterways” for verification, the constraints such as the water utilization coefficient of the channel system need to be comprehensively considered. Methods such as “when the model is insufficient, make up with data, and when the data is insufficient, make up with the model” are used to transform the “stack of rectangular strips” into a “flow-water level curve”.
1. If the channel section to be verified is provided with flow and water level monitors, the results of the simulation should be numerically fitted based on monitored values.
2. If the channel section to be verified is not provided with the monitors, the results should be smoothed into a spline curve based on the three characteristic points on the stack of rectangular strips.

Furthermore, after the step of comparing calculated results (i.e., predicted water condition information) with actual monitoring results (i.e., actual monitoring water condition information) and revising the parameters of the digital waterway as follows.

An irrigation scheduling plan is established. Based on multiple information sources, the water conditions at the water intake gate are simulated, and water is allocated to the field outlets.

The irrigation scheduling plan includes: information of gates on opening and closing times, openings, planned flow rates, duration, and total water usage.

The simulation of the water conditions at the water intake gate includes: the system should randomly generate (or use the current instantaneous water conditions) to estimate the water conditions over a future period. In actual application, the flow-water level curve is usually manually drawn based on upstream hydrological monitoring data, pump station schedules, precipitation, and mountain floods.

After discretizing the physical waterways into channel sections and forming the binary tree, the water flow movement in each small channel section (on the tree node) is generalized as the movement of the rectangular strips. The water flow movement between channel sections (between tree nodes) is generalized as operations such as unpacking and boxing of rectangular strips.

Specifically, the water flow movement form in each channel section (on the tree node) are divided into: the open channel uniform flow, water storage before closure of a regulating gate, pressurized water discharge when the regulating gate is opened, and submerged flow caused by rise of the water level due to the submerged dam.

In response to the water flow movement form corresponding to the open channel uniform flow: a natural flow of open channel water is generalized as the open channel uniform flow, and the water flow movement equation is expressed as Q=SV, where Q represents a flow rate, S represents a cross-sectional area of a channel section, and V represents a flow velocity.

In response to a water flow movement form corresponding to the water storage before closure of the regulating gate: when an opening of the regulating gate decreases, the water storage is conducted in the channel section in front of the regulating gate, causing a water level to rise gradually, and the water flow movement equation is expressed as R=ΔQT, where R represents storage capacity, ΔQ represents a difference between a flow rate entering a channel section and a flow rate exiting the channel section, and T represents a time period.

In response to a water flow movement form corresponding to the pressurized water discharge when the regulating gate is opened: when the regulating gate is opened to release water, thereby causing the opening of the regulating gate to gradually increase. The water flow movement equations is expressed as Q=F(H, h, a, e, dh/dt, dH/dt, S/s), where Q represents a flow rate, F represents a function of Q, H represents a water level in front of the regulating gate, h represents a water level behind the regulating gate, a represents the opening of the regulating gate, e represents a flow coefficient, t represents time, S represents the a cross-sectional area of a channel section, and s represents a cross-sectional area of another channel section.

In response to the water flow movement form corresponding to the submerged flow caused by rise of the water level due to the submerged dam: when diverting water to fields with higher terrain, a submerged dam is used to raise the water lever, and the water flow movement equation is expressed as ΔZ=F(q, H, b, V, e), where q represents a flow rate across the submerged dam, F represents a function of q, H represents a total water head at a top of the submerged dam, b represents a top width of an overflow channel section of the submerged dam, V represents a flow velocity, e represents a flow coefficient, and ΔZ represents a backwater height.

The water flow movement between adjacent two nodes in the digital waterways can be generalized into the following three aspects.
1. After the water flow from the upstream channel section in the digital waterways flows into the downstream channel section, the average velocity and water level need to be recalculated based on the physical parameters of the downstream channel section and hydraulic formulas. Moreover, the corresponding rectangular strip needs to shift to the right by ΔT=L/V.
2. When water storage, discharge, or backwater occurs, the backflow phenomenon often happens (that is, the water conditions at node V₂ₙ of the channel section often affect the water flow movement at node Vₙ). Therefore, after calculating the water level, flow, storage volume, and water level change rate at V₂ₙ, it is necessary to recalculate the representation of the rectangular strip above Vₙ.
3. When diversion or confluence occurs, the addition and subtraction of rectangular strips should meet the properties of the water flow, such as flow addition and time shift.

Among them, the physical parameters of the above channel sections are constants obtained through measurement. The flow coefficients of the gates mentioned above are constants obtained through repeated experiments and calibration. In the above open channel uniform flow, the relationship between flow and water level is obtained through the Chezy formula. The water condition information at the above nodes includes: the flow, velocity, water level, and duration of the node.

When the water flow passes through the water intake gate for diversion or confluence, the calculation of flow is similar to the unpacking and boxing of rectangular strips, which can be further abstracted into a mathematical problem. The equation can be solved through iteration, and the significance of the solution can be discussed.

All hydraulic structures are coded as follows: a parent node of the binary tree is set as Vₙ, a child node is set as V₂ₙ, and a second child node is set as V₂ₙ₊₁. The parent node Vₙ is an upstream channel section of the child node V₂ₙ, the second child node V₂ₙ₊₁ is a water intake gate, and a direction corresponding to an increasing order represents a water flow direction, a water intake gate on a main channel {V₁, V₂, . . . V₂ₙ, . . . } is represented as Gᵢ∈{V₂ₙ}, and a regulating gate on the main channel {V₁, V₂, . . . V₂ₙ, . . . } is represented as Pᵢ∈{V₂ₙ₊₁}. If the water situation at the water intake gate V₀₆ is affected, the gate opening G is expressed as follows:

$$[ \begin{matrix}{G}_{1 , j} \\ {G}_{2 , j} \\ … \\ {G}_{i , j}\end{matrix} ] = [ \begin{matrix}{G}_{1 , 601} & {G}_{1 , 602} & … & {G}_{1 , 630} \\ {G}_{2 , 601} & {G}_{2 , 602} & … & {G}_{2 , 630} \\ … & … & … & … \\ {G}_{i , 601} … & … & … & {G}_{i , j}\end{matrix} ]$$

The flow V_{(2i+1, j)} and tributary V₂ᵢ₊₁ are expressed as follows:

$$[ \begin{matrix}{V}_{3 , j} \\ {V}_{3 , j} \\ … \\ {V}_{2 i + 1 , j}\end{matrix} ] = [ \begin{matrix}{V}_{3 , 601} & {V}_{3 , 602} & … & {V}_{3 , 630} \\ {V}_{5 , 601} & {V}_{5 , 602} & … & {V}_{5 , 630} \\ … & … & … & … \\ {V}_{2 i + 1 , 601} … & … & … & {V}_{2 i + 1 , j}\end{matrix} ]$$

1. The equation V_{(2i+1, j)}=F(V₀ⱼ, Gᵢⱼ) is used to calculate the flow distribution plans for different inflow rates and gate operation schemes of the tributaries. In the future, it will be used to innovate flow measurement methods, corroborate with flow monitoring equipment, and serve as evidence for water fee collection.
2. The equation Gᵢⱼ=F(V₀ᵢ, V_{(2i+1, j)}) is used to calculate the timing and opening of gate operations for each tributary. In the future, it will be used to plan gate operation times, reasonably arrange river patrol schedules, and reduce the frequency of patrols.
3. The equation Vᵢⱼ=F(V_{(2i+1, j)}, Gᵢⱼ) is used to calculate when the peak irrigation flow arrives at each channel section and the duration of the flood peak. In the future, it can be used for dam safety alerts and staggered irrigation.

The calculation steps are as described above. Graphically, the rectangular strips must be repackaged or split into a smaller rectangle as it passes through each tree node.

Since the physical parameters of the physical waterways, the water movement environment, and the coefficients of the gate remain unchanged over the years, the motion constraint parameters of the rectangular strips can be calibrated in advance. The flow distribution at each tributary outlet depends only on two independent variables of the water conditions at the water intake gate and the gate opening. By randomly simulating the inflow water conditions V₀ and simulating the gate opening G, the movement of the water flow in the digital twin open channel can be simulated, and the spatiotemporal distribution of the downstream water volume can be calculated. In practical applications, the design of finite elements can be referenced, using smaller time slices ΔT, channel section units ΔL, or flow states ΔQ.

The method of numerical simulating and modeling for open channel uniform flow is a core component of the irrigation scheduling decision support system. It transforms the irrigation application, intelligent gates, water condition monitoring, and geographic information system (GIS) base map of irrigation area into digital water. Coupled with the middleware services of irrigation operation collaboration, dike safety early warning, water use supervision, and water volume statistical analysis, it provides business application support for the irrigation scheduling plan, water resource management, irrigation schedule optimization, historical water condition review, and water fee dispute resolution, as shown in FIG. 6.

In the irrigation scheduling management platform, the transparent layer between the application layer and the data acquisition layer is the “numerical simulating and modeling open channel uniform flow module.” Uniform flow is a ubiquitous manifestation of water movement during irrigation, suitable for large-scale, long-term water management plans, statistical analysis, organizational execution, feedback tracing, etc. In specific applications, it is advisable to concretize it into specific subclasses according to the site conditions to meet different needs. It hides the real flow field and flow state of the channel water, calibrates and cyclically deduces and verifies the water flow data, transforming the “disordered water flow movement” into “ordered rectangular strip movement,” and promoting collaboration between schedulers, gate administrators, and water users.

Through the numerical simulating and modeling of open channel uniform flow, the digital logical relationship between “physical parameters of open channels, hydraulic coefficients, coefficients of the gates” and “irrigation operations” can be explored, laying the research foundation for irrigation scheduling (irrigation operation scheduling) algorithms. It provides a research tool for coordinating the relationship between many irrigation management elements (including but not limited to personnel organization, water saving supervision, river patrol plans, multi-source water management) and the operation of gates (time, opening, planned flow, duration, total water use), some of which are complementary, some are in conflict, and some have priority levels, in order to seek the optimal irrigation management plan.

In an embodiment, at the channel head, an irrigation operation schedule plan can be established using a “stack of rectangular strips,” which is conducive to gate scheduling management. In the middle reaches, the water transmission process can be numerically fitted to intuitively display the changes in water conditions. Δt the water intakes, various flow rates can be predicted to improve the measurement accuracy of flow meters. This can be used to analyze whether the irrigation operation can timely meet the needs of crops, whether the work schedule is reasonable, and whether the gate operation sequence is in line with the river patrol route. When the monitored flow does not match the planned flow, it can also promptly identify the location of congestion, analyze the areas of abnormal water use, and verify the flow monitoring equipment. It urges farmers to irrigate according to the plan, making the overall irrigation operation orderly.

In short, simulating uniform flow is the primary stage of water conservancy informatization and serves as a universal, generalized, and representative description of digital twin water conservancy. It is a prerequisite and foundation for further simulating complex flow fields and flow regimes. It acts as a data accumulation and validation tool for the research of irrigation scheduling operation scheduling algorithms and is an essential component of intelligent irrigation areas. By integrating the various functional modules of the comprehensive irrigation scheduling management platform and implementing the irrigation application management system, the disclosure can be applied to efficiently formulate irrigation scheduling plans, reasonably arrange irrigation operation schedules, guide the management of intelligent gates, coordinate mutual supervision among farmers to save water, optimize river patrol management work, and other application effects. In the long-term operation of the irrigation management service platform, it can improve the accuracy of water measurement, reduce the construction cost of modern irrigation areas, enhance the efficiency of water resource utilization, and simultaneously collect big data on irrigation application management. This improves the service model of modern irrigation area irrigation management, promotes the irrigation management business into a path of advanced planning, refined management, dynamic planning, and information-based development, and implements the modern irrigation area management concept of serving agriculture, rural areas, and farmers, with a promising application prospect.

The various embodiments in the specification are described in a progressive manner, with each embodiment emphasizing its differences from other embodiments. The same and similar parts between the embodiments can be referred to each other.

The disclosure uses specific embodiments to explain the principles and implementation methods of the disclosure. The above examples are only used to help understand the core idea of the disclosure. Meanwhile, for those skilled in the art, there may be changes in the specific embodiment and application scope based on the idea of the disclosure. In summary, the content of the specification should not be construed as limiting the disclosure.

What is claimed is:

1. A method for numerical simulating and modeling uniform flow in open channels, comprising:
constructing digital waterways composed of a binary tree based on physical waterways;
generalizing water flow movement environment in the physical waterways into node parameters corresponding to the digital waterways;
performing dimensionality reduction a water flow movement equation in the physical waterways into a movement equation of rectangular strips on the binary tree in the digital waterways, wherein the movement equation of rectangular strips comprises types of water movement within tree nodes and impact of movement changes between the tree nodes, the impact of movement changes represents influence of changes in a water channel and water flow movement on upstream water conditions and downstream water conditions, and the rectangular strips are configured to describe manifestation of water conditions at the tree nodes on a time axis; and
calculating changes in the downstream water conditions based on the node parameters and the movement equation, and determining an irrigation scheduling plan for production cooperation based on the changes in the downstream water conditions, wherein the irrigation scheduling plan comprises information of gates on opening and closing times, openings, planned flow rates, duration, and total water usage.

2. The method for numerical simulating and modeling the uniform flow in the open channels as claimed in claim 1, wherein the constructing digital waterways composed of a binary tree based on physical waterways comprises:
determining a topological structure of the digital waterways;
discretizing the digital waterways;
determining a digital water movement constraint condition; and
determining water movement equation in the digital waterways;
wherein the determining a topological structure of the digital waterways comprises:
generalizing the physical waterways into a tree-like structure based on a natural structure of an irrigation area, and simplifying the tree-like structure into the binary tree owing to there is no need to distinguish between left and right banks in a process of simulating and modeling;
wherein the discretizing the digital waterways comprises: dividing the physical waterways into multiple channel sections based on positions of water intakes, and the multiple channel sections have a same constraint condition and a same water movement equation;
wherein the digital water movement constraint condition comprises: physical parameters of the physical waterways, physical parameters of the gates, flow coefficients of the gates, and a fluid mechanics constraint; and
wherein a water flow movement form of the water movement equation in the digital waterway comprises: an open channel uniform flow from a natural flow, an open channel temporarily stores water cause by closing a regulating gate, drainage cause by open the gate, and a submerged flow cause by a submerged dam.

3. The method for numerical simulating and modeling the uniform flow in the open channels as claimed in claim 2, wherein the discretizing the digital waterways further comprises coding the multiple channel sections, comprising:
setting a parent node of the binary tree as Vₙ, a child node as V₂ₙ, and a second child node as V₂ₙ₊₁, wherein the parent node Vₙ is an upstream channel section of the child node V₂ₙ, the second child node V₂ₙ₊₁ is a water intake gate, and a direction corresponding to an increasing order represents a water flow direction, and a water intake gate on a main channel {V₁, V₂, . . . V₂ₙ, . . . } is represented as Gᵢ∈{V₂ₙ}, and a regulating gate on the main channel {V₁, V₂, . . . V₂ₙ, . . . } is represented as Pᵢ∈{V₂ₙ₊₁};
wherein the determining a topological structure of a channel system comprises addition calculations of convergence or summarize irrigation applications, comprising:
setting water condition of an upstream node of the parent node Vₙ as a sum of water condition of a downstream node of the child node V₂ₙ and water condition of the water intake gate of the second child node V₂ₙ₊₁, wherein the addition calculation process is graphically represented as a union operation of two rectangular strips over a time period T, and is mathematically expressed as Vₙ=V₂ₙ+V₂ₙ₊₁;
wherein the determining a topological structure of a channel system comprises subtraction calculations of distributary or water intake diversion, which is an inverse operation of the addition calculation process, and the subtraction calculation process comprises:
determining the water condition of the downstream node over the time period T as a difference between the water condition of the upstream node and the water condition of the water intake gate, wherein the subtraction calculation process is graphically represented as a difference operation of two rectangular strips over the time period T, and is mathematically expressed as V₂ₙ=Vₙ−V₂ₙ₊₁;
wherein the determining a topological structure of the digital waterways further comprises a calculation process of displacement, comprising:
after passing through a channel section with a length of Lₙ, expressing water condition on a first channel section as follows on a second channel section: the water condition of the child node V₂ₙ is represented as a right shift of the rectangular strip on the parent node Vₙ by Lₙ/Vₙ; and
wherein water conditions of adjacent two nodes are obtained by a union operation, an intersection operation, a difference operation, and a shift operation in two dimensions of time and flow rate.

4. The method for numerical simulating and modeling the uniform flow in the open channels as claimed in claim 2, wherein the determining a water movement equation in the digital waterways comprises:
in response to the water flow movement form corresponding to the open channel uniform flow, performing dimensionality reduction a natural flow of open channel water as the open channel uniform flow, and expressing the water flow movement equation as Q=SV, where Q represents a flow rate, S represents a cross-sectional area of a channel section, and V represents a flow velocity;
in response to a water flow movement form corresponding to the water storage before closure of the regulating gate, when an opening of the regulating gate decreases, conducting the water storage in the channel section in front of the regulating gate, causing a water level to rise gradually, and expressing the water flow movement equation as R=ΔQT, where R represents storage capacity, ΔQ represents a difference between a flow rate entering a channel section and a flow rate exiting the channel section, and T represents a time period;
in response to a water flow movement form corresponding to the pressurized water discharge when the regulating gate is opened, when the regulating gate is opened to release water, thereby causing the opening of the regulating gate to gradually increase, expressing the water flow movement equation as Q=F(H, h, a, e, dh/dt, dH/dt, S/s); where Q represents a flow rate, F represents a function of Q, H represents a water level in front of the regulating gate, h represents a water level behind the regulating gate, a represents the opening of the regulating gate, e represents a flow coefficient, t represents time, S represents a cross-sectional area of a channel section, and s represents a cross-sectional area of another channel section;
in response to the water flow movement form corresponding to the submerged flow caused by rise of the water level due to the submerged dam, when diverting water to fields with higher terrain, a submerged dam is used to raise the water lever, expressing the water flow movement equation as ΔZ=F(q, H, b, V, e), where q represents a flow rate across the submerged dam, F represents a function of q, H represents a total water head at a top of the submerged dam, b represents a top width of an overflow channel section of the submerged dam, V represents a flow velocity, e represents a flow coefficient, and ΔZ represents a backwater height.

5. The method for numerical simulating and modeling the uniform flow in the open channels as claimed in claim 1, wherein the calculating changes in the downstream water conditions based on the node parameters and the movement equation comprises:
calculating water condition at each node, water condition of an upstream node of each node, physical parameters of a channel section, the openings of the gates, and flow coefficients of the gates when the rectangular strips move on the binary tree, where V_{water condition of downstream node}=F (V_{water condition of upstream node}, G_{opening of gate}); and
using the water condition of the downstream node as a dependent variable, and using the water condition of the upstream node and the openings of the gates as independent variables to iteratively calculate representation of the rectangular strips at all downstream nodes, and converting the representation into node water condition information, wherein the physical parameters of the channel section are constants obtained through measurement, the flow coefficients of the gates are constants obtained through testing and calibration, and the node water condition information comprises: a flow rate, a velocity, a water level, and duration corresponding to the node.

6. The method for numerical simulating and modeling the uniform flow in the open channels as claimed in claim 5, wherein a process for iteratively calculating the representation of the rectangular strips at all downstream nodes and converting the representation into the node water condition information comprises:
manifesting the representation of the rectangular strips at the all downstream nodes as a stack of rectangular strips, and using spline curves to smooth the stack of rectangular strips, thereby forming a predicted water condition information;
comparing the predicted water condition information with actual monitoring water condition information, and accordingly revising parameters of the digital waterways; and
determining, based on the predicted water condition information and the actual monitoring water condition information, a flow loss and an energy loss during a water conveyance process, obtaining the node water condition information based on the flow loss and the energy loss.
